(19) United States
(12) Patent Application Publication
(10) Pub. No.: US 2006/0171574 A1
(43) Pub. Date: Aug. 3, 2006

(54) Graphical healthcare order processing system and method

(76) Inventors: Brian DelMonego, Chester Springs, PA (US); Betty Fink, Bear, DE (US); Gary Grzywacz, Harleysville, PA (US); James Pressler, West Chester, PA (US); Donald Taylor, Downingtown, PA (US); Arnold Teres, Broomall, PA (US)

Correspondence Address: Siemens Corporation;Intellectual Property Department, 170 Wood Avenue South, Iselin, NJ, 08830, US

(21) Appl. No.: 11/272,616

(22) Filed: Nov. 14, 2005

Related U.S. Application Data
(60) Provisional application No. 60/627,375, filed on Nov. 12, 2004.

(51) Int. Cl. G06K 9/00

(52) U.S. Cl. 382/128

(57) ABSTRACT

The embodiments of the present invention relate to a system and method for ordering medical procedures comprising initiating the generating of data that represents a first display image representing a human body; identifying a region of the human body according to a first command from a user; presenting a second display image comprising at least one medical procedure associated with the identified region of the human body, thereby enabling the user to select at least one medical procedure for order; and initiating ordering of the at least one selected medical procedure, whereby the ordering process is simplified and expedited.

This is a non-provisional application of Provisional Application Ser. No. 60/627,375 to DelMonego et al. filed Nov. 12, 2004.

### FIELD OF THE INVENTION

The embodiments of the present invention relate to a computer-implemented graphical healthcare order processing system and method, particularly to a system and method for ordering medical procedures for a patient by navigating a graphical representation of the human body.

### BACKGROUND OF THE INVENTION

Typically, in existing systems for ordering medical procedures for a particular patient, a user selects a procedure using textual information. For example, a user can select a procedure based upon the department performing the procedure, a short description of the procedure, or a detailed description of the procedure. However, these methods of selecting procedures to be ordered for a patient can be very confusing, particularly because in many cases each medical facility (e.g., a hospital) uses different terminology for its procedure descriptors, more particularly abbreviated descriptors. In addition, the descriptors are often not intuitive such that a user would not readily associate the descriptors with the procedure they describe, for example, a Cat Scan procedure for the abdomen may be described as “PXR 2020.” As a result, the existing systems are prone to error and oversight, particularly in those facilities with a high turnover rate of the staff.

Thus, there is a need within the industry for a healthcare procedure ordering system and method that uses a graphical representation of the human body, which refines the list of appropriate procedures associated with a particular region or sub-region of the human body, based upon a physical depiction of the human body.

### SUMMARY OF THE INVENTION

An exemplary embodiment of the present invention comprises a system for ordering medical procedures for a patient comprising a display processor for initiating generating of data that represents a first display image representing a human body; identifying a region of the human body according to a first command from a user; presenting a second display image comprising at least one medical procedure associated with the identified region of the human body; thereby enabling the user to select at least one medical procedure for order; and an ordering processor for initiating ordering of the at least one selected medical procedure.

### BRIEF DESCRIPTION OF THE DRAWINGS

All functions and processes shown in the Figures may be implemented in hardware, software or a combination of both.

FIG. 1 is a block diagram showing a computer system according to an exemplary embodiment of the present invention.

FIG. 2 is a block diagram showing a computer system according to an exemplary embodiment of the present invention.

FIG. 3 is a block diagram showing a method according to an exemplary embodiment of the present invention.

FIG. 4 is a graphical representation according to an exemplary embodiment of the present invention.

FIG. 5 is a graphical representation according to an exemplary embodiment of the present invention.

### DETAILED DESCRIPTION

Although the embodiments of the present invention are described in the context of medical procedures for the human body, this is exemplary only. The embodiments of the present invention are also applicable in other medical disciplines (e.g., veterinary medicine and dentistry). Moreover, the embodiments of the present invention are described in the context of radiology, which again, is only exemplary. These embodiments are also applicable in other areas of medicine, wherein each specialty can populate its particular list of medical procedures to correspond to the relevant human body regions and sub-regions.

An embodiment of the present invention comprises a computer-implemented system and method for ordering medical procedures comprising initiating the generating of data that represents a first display image representing a human body; identifying a region of the human body according to a first command from a user; and presenting a second display image comprising at least one medical procedure (e.g., radiology procedures) associated with the identified region of the human body, thereby enabling the user to select at least one medical procedure for order; and initiating ordering of the at least one selected medical procedure.

The embodiments of the present invention can further comprise identifying at least one sub-region of the human body according to at least a second command from the user, initiating the generating of data that represents a third image display representing the sub-region of the human body, wherein the identified sub-region of the human body is expanded; presenting a fourth display image comprising at least one medical procedure associated with the identified and expanded sub-region of the human body, thereby enabling the user to select at least one medical procedure for order; and initiating the ordering of the at least one selected medical procedure.

The embodiments of the present invention can further comprise enabling the user to associate particular radiology procedure descriptors with particular regions of the displayed human body.

The first display image representing a human body may be in the form of a two-dimensional image (2-D) or a three-dimensional object (3-D). The displayed human body is preferably a patient-neutral representation of the human anatomy, such that it is not decipherable as either male or female. However, the first display image may be supplemented to also display the appropriate gender-specific genitalia in those instances where a user desires to order a radiology procedure for those body regions/sub-regions.

The term “sub-region” as used herein, is meant to include several tiers of sub-regions, such that the embodiments of the present invention are able to generate data representing at least one graphical representation a sub-region (second tier) of a sub-region (first tier) and so on. For example a user may identify the upper body region of the human body. Subsequently the user can execute the necessary command to identify an arm sub-region (first tier), wherein using further commands the user may identify a hand sub-region (second tier), a finger sub-region (third tier) and ultimately a finger bone sub-region (fourth tier). In each case the sub-region is expanded for easier viewing and identifying of further sub-regions. The number of tiers of sub-regions in the embodiments of the present invention is limited only by the availability of medical procedures associated with that particular sub-region.

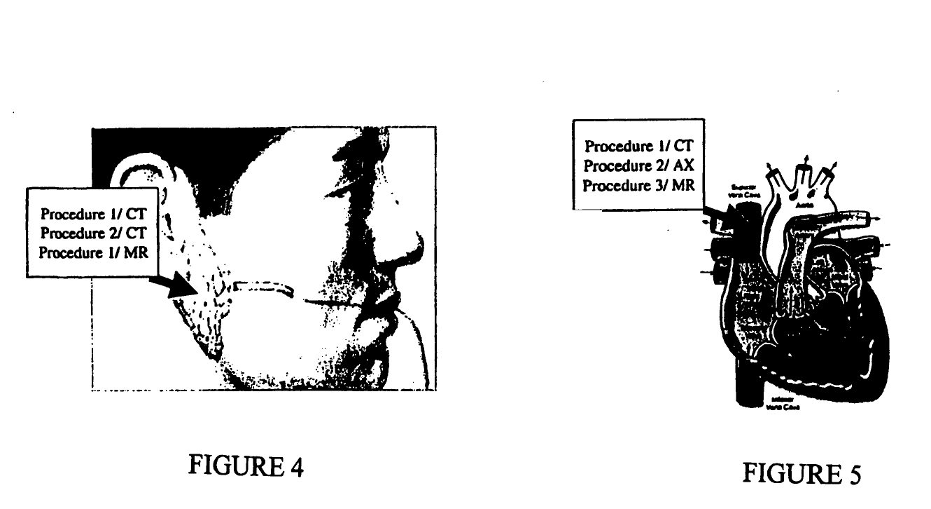

In an exemplary method according to the embodiments of the present invention, a user can identify a sub-region of the human body, wherein the identified sub-region is expanded or enlarged to the point where the local anatomy of that sub-region is shown in greater detail and is readily discernable by the user. For example as shown in FIGS. 4 and 5, when a physician desires to order a saliogram (i.e., the imaging of the salivary glands), which is an uncommon procedure, the user can navigate the head and neck region of the displayed human body to ascertain the associated radiology procedures in an attempt to locate the salivary glands. Upon executing the appropriate command (e.g., moving or placing a cursor over the particular region/sub-region of the graphical body representation) a listing of at least one medical procedure (i.e., the second display image) associated with the head and neck region of the human body is displayed. However in this instance, greater detail is required, and therefore, the user can execute a second command (e.g., clicking a mouse on the head and neck region of the human body), wherein the identified sub-region such as the facial sub-region is expanded and easily recognizable. Again upon the user executing the appropriate command (e.g., moving or placing a cursor over the facial region of the body) a listing of at least one medical procedure (i.e., the second display image) associated with the facial sub-region is displayed. For even greater detail, the user can execute a third command, wherein the identified sub-region such as the salivary gland and/or salivary gland duct is displayed. Upon executing the appropriate command a listing of at least one medical procedure associated with the salivary gland and salivary gland duct is displayed and may be selected by the user, whereby ordering can be initiated. As a result, the overall listing of procedures is refined to those that are region or sub-region specific or appropriate and the user can then select and order the desired procedure. Thus, the order entry process is expedited.

In another exemplary method according to the embodiments of the present invention, a user (e.g., a physician) may desire to order a chest 2-view procedure, the user is employed at three (3) different hospitals, those being Hospital A, Hospital B and Hospital C. The descriptor used by Hospital A for the chest 2-view is: “RAD1010—Chst 2 View”. The descriptor used by Hospital B for the same procedure is: “BRD 2917—Two View Chest” and the descriptor used by Hospital C for the same procedure is: “ZC2—Chst 2 VW”. In order for the user to efficiently and correctly select the desired procedure, the user will need to know the various codes utilized among Hospitals A, B and C. In addition, search strategies to identify the correct procedure will also differ due to the hospitals differing descriptors. However, in using the embodiments according to the present invention, the user can simply navigate the displayed graphical representation of the human body, identify the appropriate region and/or sub-region(s) and select the desired procedure, thereby initiating the ordering process.

In effectuating the embodiments according to the present invention there is a bidirectional link between the displayed graphical representation of the human body and the various lists of at least one medical procedure for the various regions and/or sub-regions. The dependencies between the regions or sub-regions and the associated procedure lists are controlled by user-defined attributes, wherein upon executing the appropriate command the user determines which sub-region and associated list of at least one medical procedure is viewed. The user can readily move among the various regions and sub-regions and listings of medical procedures associated therewith unless otherwise restricted by the user. Upon the user executing the appropriate command (e.g., moving or placing a cursor over the region/sub-region of the body or medical procedure list and clicking the mouse button), the user can navigation among the region/sub-region and associated medical procedures.

Using the computer-implemented system and method according to the embodiments of the present invention, a hospital or other medical facility is able to automate workflow with respect to ordering medical procedures for patients. Thus, the hospital or other medical facility operates more efficiently and provides more effective patient care.

The embodiments of the present invention are preferably implemented on a computer, or network of computers as an executable application. The executable application displays on a computer screen, a graphical depiction of the human body (e.g., either a region or sub-region(s)) as well as the corresponding procedure(s) and enables the user to order a medical procedure.

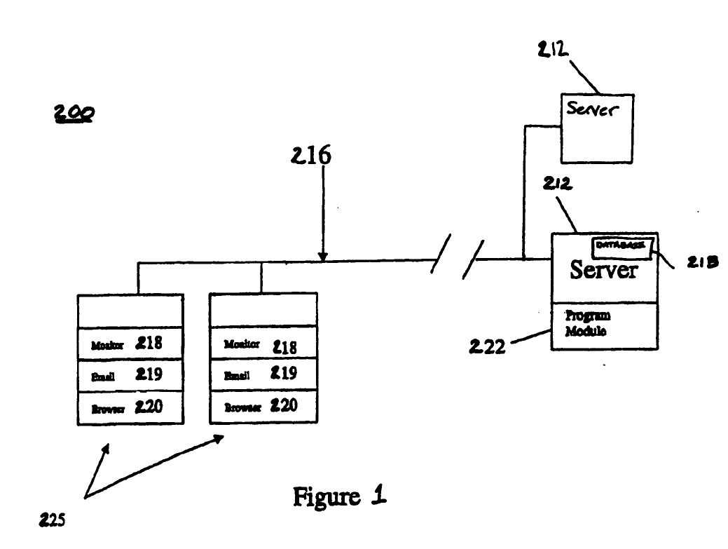

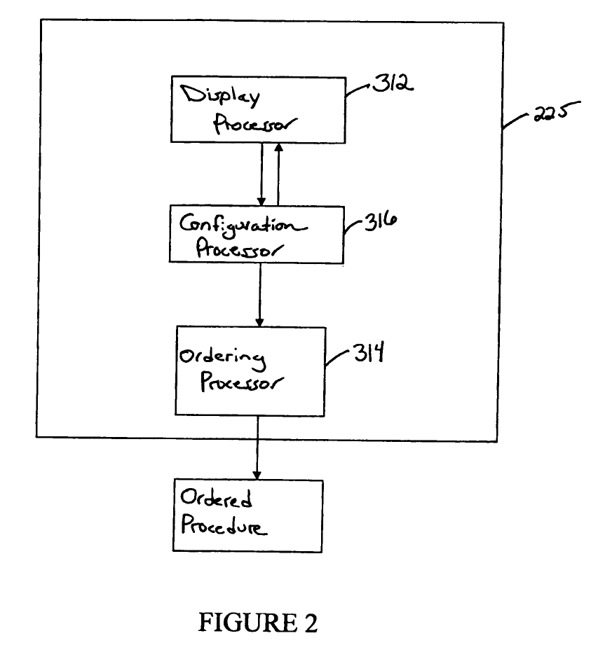

FIG. 1 shows a client-server computer system 200 according to an exemplary embodiment of the present invention, which may be utilized to carry out a method according to an exemplary embodiment of the present invention. The computer system 200 includes a plurality of server computers 212 and a plurality of user computers 225. The server computers 212 and the user computers 225 may be connected by a network 216, such as for example, an Intranet or the Internet. The user computers 225 may be connected to the network 216 by a dial-up modem connection, a Local Area Network (LAN), a Wide Area Network (WAN), cable modem, digital subscriber line (DSL), or other equivalent connection means (whether wired or wireless).

Each user computer 225 preferably includes a video monitor 218 for displaying information. Additionally, each user computer 225 preferably includes an electronic mail (e-mail) program 219 (e.g., Microsoft Outlook®) and a browser program (e.g., Microsoft Internet Explorer®, Netscape Navigator®, etc.), as is well known in the art. Each user computer may also include various other programs to facilitate communications (e.g., Instant Messenger™, NetMeeting™, etc.), as is well known in the art.

One or more of the server computers 212 preferably include a program module 222 (i.e., the executable application described above) which allows the user computers 225 to communicate with the server computers 212 and each other over the network 216. The program module 222 may include program code, preferably written in Hypertext Mark-up Language (HTML), JAVA™ (Sun Microsystems, Inc.), Active Server Pages (ASP) and/or Extensible Markup Language (XML), which allows the user computers 225 to access the program module through browsers 220 (i.e., by entering a proper Uniform Resource Locator (URL) address). The exemplary program module 222 also preferably includes program code for facilitating a method of simulating leadership activity among the user computers 225, as explained in detail below.

At least one of the server computers 212 also includes a database 213 for storing information utilized by the program module 222 in order to carry out the embodiments of the method for ordering medical procedures. The data representing display images representing a human body as well as the regions and sub-regions thereof, the data representing the associated listings of the at least one medical procedures can be stored in the database. Although the database 213 is preferably internal to the server as shown in FIG. 1, those of ordinary skill in the art will realize that the database 213 may alternatively comprise an external database. Additionally, although the database 213 is preferably a single database as shown in FIG. 1, those of ordinary skill in the art will realize that the present computer system may include one or more databases coupled to the network 216.

The embodiments of the present invention also include a computer-readable medium having embodied thereon a computer program for processing by a machine, the computer program comprising a segment of code for each of the method steps. The embodiments of the present invention also include a computer data signal embodied in a carrier wave comprising each of the aforementioned code segments.

In order to perform some of the functions of the method for ordering medical procedures, at least one of the user computers 225 or server computers 212 may include a display processor 312 for initiating the generation of data that represents a first display image representing a human body, identifying a region of the human body according to a first command from a user; and presenting a second display image comprising at least one medical procedure (e.g., radiology procedures) associated with the identified region of the human body, thereby enabling the user to select at least one medical procedure for order; and an ordering processor 314 for initiating ordering of the at least one selected medical procedure. At least one of the user computers 225 or server computers 212 may also use the display processor 312 for identifying at least one sub-region of the human body according to at least a second command from the user, initiating the generating of data that represents a third image display representing the sub-region of the human body, wherein the identified sub-region of the human body is expanded; presenting a fourth display image comprising at least one medical procedure associated with the identified and expanded sub-region of the human body. At least one of the user computers 225 or server computers 212 may also include a configuration processor 316 for enabling the user to associate particular radiology descriptors with particular regions of the displayed human body.

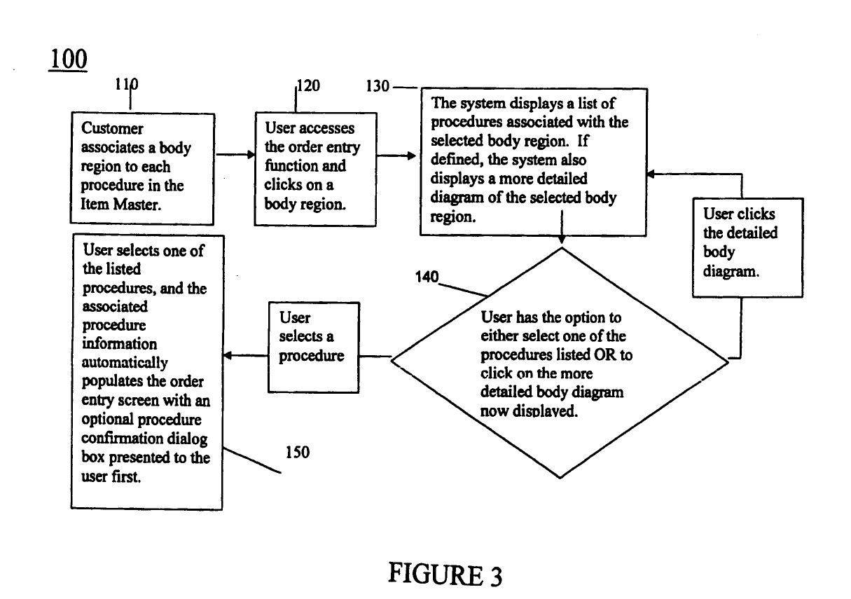

FIG. 3 is a block flow diagram showing an exemplary method 100 for ordering medical procedures that includes a first step 110 of a user associating a region/sub-region of the displayed human body to the at least one listed medical procedure. At step 120, the user can access the order entry function and execute a command with respect to a region of the displayed human body. At step 130, a list of at least one medical procedure corresponding to the identified region is displayed or the sub-region of the human body is displayed. At step 140, the user has the option to either select one of the listed medical procedures or may wish to further expand a sub-region. If the user decides to further expand a sub-region 150, the user is returned to step 130 however the procedure list is now associated with that expanded sub-region. Alternatively, a user may select one of the listed medical procedures in step 160. At step 170, the user selects one of the listed medical procedures and the information associated with that selected procedure then automatically populates an order entry screen and includes an optional procedure confirmation dialog box presented to the user first.

An executable application as used herein comprises code or machine-readable instruction for implementing pre-determined functions, including those of an operating system, healthcare information system or other information processing systems, for example, in response to a user command or input. An executable procedure is a segment of code (machine-readable instruction), subroutine, or other distinct section of code or portion of an executable application for performing one or more particular processes and may include performing operations on received input parameters (organ response to received input parameters) and provide resulting output parameters.

A processor as used herein is a device and/or set machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention

What is claimed is:

1. A system for ordering medical procedures comprising
a display processor for initiating generating of data that represents a first display image representing a human body, identifying a region of the human body according to a first command from a user; presenting a second display image comprising at least one medical procedure associated with the identified region of the human body, thereby enabling the user to select at least one medical procedure for order; and
an ordering processor for initiating ordering of the at least one selected medical procedure.

2. The system according to claim 1, further comprising the data processor:
identifying at least one sub-region of the human body according to at least a second command from the user, initiating the generating of data that represents a third image display representing the sub-region of the human body, wherein the identified sub-region of the human body is expanded; and presenting a fourth display image comprising at least one medical procedure associated with the identified and expanded sub-region of the human body, thereby enabling the user to select at least one medical procedure for order.

3. The system according to claim 1, wherein the human body is displayed as a two-dimensional image or three-dimensional object.

4. The system according to claim 1, wherein the human body further comprises gender specific genitalia.

5. The system according to claim 1, further comprising:
a configuration processor for enabling the user to associate particular radiology descriptors with particular regions of the displayed human body.

6. A method for ordering medical procedures comprising:
initiating the generation of data that represents a first display image representing a human body;
identifying a region of the human body according to a first command from a user;
presenting a second display image comprising at least one medical procedure associated with the identified region of the human body, thereby enabling the user to select at least one medical procedure for order; and
initiating ordering of the at least one selected medical procedure.

7. The method according to claim 6, further comprising:
prior to initiating ordering, identifying at least one sub-region of the human body according to at least a second command from the user, initiating the generating of data that represents a third image display representing the sub-region of the human body, wherein the identified sub-region of the human body is expanded; and presenting a fourth display image comprising at least one medical procedure associated with the identified and expanded sub-region of the human body, thereby enabling the user to select at least one medical procedure for order.

8. The method according to claim 6, further comprise enabling the user to associate particular radiology descriptors with particular regions of the displayed human body.

9. A computer system comprising at least one server computer; and at least one user computer coupled to at least one server through a network, wherein the at least one server computer includes at least one program stored therein, said program performing the steps of:
initiating the generation of data that represents a first display image representing a human body;
identifying a region of the human body according to a first command from a user;
presenting a second display image comprising at least one medical procedure associated with the identified region of the human body, thereby enabling the user to select at least one medical procedure for order; and
initiating ordering of the at least one selected medical procedure.

10. The system according to claim 9, further comprising the data processor
identifying at least one sub-region of the human body according to at least a second command from the user, initiating the generating of data that represents a third image display representing the sub-region of the human body, wherein the identified sub-region of the human body is expanded; and presenting a fourth display image comprising at least one medical procedure associated with the identified and expanded sub-region of the human body, thereby enabling the user to select at least one medical procedure for order.

11. The system according to claim 9, further comprise enabling the user to associate particular radiology descriptors with particular regions of the displayed human body.

12. A computer readable medium having embodied thereon a computer program for processing by a machine, the computer program comprising:
a first code segment for initiating the generation of data that represents a first display image representing a human body;
a second code segment for identifying a region of the human body according to a first command from a user;
a third code segment for presenting a second display image comprising at least one medical procedure associated with the identified region of the human body, thereby enabling the user to select at least one medical procedure for order; and
a fourth code segment for initiating ordering of the at least one selected medical procedure.

13. The medium according to claim 12, further comprising
prior to initiating ordering, a fifth code segment for identifying at least one sub-region of the human body according to at least a second command from the user, initiating the generating of data that represents a third image display representing the sub-region of the human body, wherein the identified sub-region of the human body is expanded; and
a sixth code segment for presenting a fourth display image comprising at least one medical procedure associated with the identified and expanded sub-region of the human body, thereby enabling the user to select at least one medical procedure for order.

14. The medium according to claim 12, further comprising an seventh code segment for enabling the user to associate particular radiology descriptors with particular regions of the displayed human body.

15. A computer data signal embodied in a carrier wave comprising:
a first code segment for initiating the generation of data that represents a first display image representing a human body;
a second code segment for identifying a region of the human body according to a first command from a user;
a third code segment for presenting a second display image comprising at least one medical procedure associated with the identified region of the human body, thereby enabling the user to select at least one medical procedure for order; and
a fourth code segment for initiating ordering of the at least one selected medical procedure.

16. The computer data signal according to claim 15, further comprising
prior to initiating ordering, a fifth code segment for identifying at least one sub-region of the human body according to at least a second command from the user, initiating the generating of data that represents a third image display representing the sub-region of the human body, wherein the identified sub-region of the human body is expanded; and
a sixth code segment for presenting a fourth display image comprising at least one medical procedure associated with the identified and expanded sub-region of the human body, thereby enabling the user to select at least one medical procedure for order.

17. The computer data signal according to claim 15, further comprising a seventh code segment for enabling the user to associate particular radiology descriptors with particular regions of the displayed human body.
